(19) United States
(12) Patent Application Publication
(10) Pub. No.: US 2013/0055967 A1
(43) Pub. Date: Mar. 7, 2013

(54) CUSTOMIZABLE PET WALKING DEVICE

(71) Applicant: Laura Marie Vorreyer, Encino, CA (US)

(72) Inventor: Laura Marie Vorreyer, Encino, CA (US)

(21) Appl. No.: 13/601,275

(22) Filed: Aug. 31, 2012

Related U.S. Application Data
(60) Provisional application No. 61/530,207, filed on Sep. 1, 2011.

(51) Int. Cl. A01K 27/00

(52) U.S. Cl. 119/795

(57) ABSTRACT

The invention is a device, method, and system for walking a dog. More particularly, the invention is a container that is in the shape of a dog house with a hidden attic compartment. The main house portion holds bags and cleaning wipes. The attic portion of the house may, in a hidden manner, hold credit card, keys, or money. The container is designed to attach to a pet leash and be used when walking a pet.

### CROSS-REFERENCE TO RELATED APPLICATIONS

This Non-Provisional patent application claims priority to Provisional Application No. 61/530,207, titled “Dog walking device which holds bags, cleaning wipes, keys and cards. Customizable”, filed Sep. 1, 2011, by inventor Laura Marie Vorreyer, the entire contents of which are hereby incorporated by this reference as though set forth in its entirety.

### FIELD OF THE INVENTION

The invention relates to a device, method, and system for walking a pet, such as a dog. More particularly, the invention is a container that is in the shape of a dog house with a hidden attic compartment. The main house portion holds bags and cleaning wipes. The attic portion of the house may, in a hidden manner, hold credit cards, keys, or money. The container is designed to attach to a pet leash and be used when walking a pet.

### BACKGROUND OF THE INVENTION

For the past several decades, society has demanded that pet owners pick up the solid waste of their pets when walking their pets in public areas. This has led to the need for owners to carry baggies that are used to scoop up the waste so that it can be disposed of properly. Because this task can be messy, it would be beneficial to have a source of cleaning wipes, wet or dry, to aid in cleaning up the waste.

Thus, what is needed is a portable container for walking pets that includes a compartment for bags and cleaning wipes.

### SUMMARY OF THE INVENTION

To minimize the limitations in the prior art, and to minimize other limitations that will become apparent upon reading and understanding the present specification, the present invention discloses a new and useful device, method, and system for walking a dog comprised of a container shaped like a dog house. The container includes a main house portion that hold bags and cleaning wipes, with dispenser slots, and a roof portion that may hold keys, money, or credit cards. The container is designed to be attached to a leash for easy use when walking a dog.

One embodiment of the invention is a dog walking device comprising: a main compartment portion; and a top portion. The main compartment portion is configured to contain a plurality of bags and a plurality of cleaning wipes wherein the top portion removably connects to the main compartment portion. Preferably, the top portion is comprised of an outer cover, an inner hatch, and a secondary compartment. Preferably, the secondary compartment is formed by the outer cover and the inner hatch. Preferably, the inner hatch removably connects to the cover. The device may further comprise a connector, wherein the connector is attached to an outer surface of the outer cover. Preferably, the connector enables the dog walking device to connect to a pet leash. Preferably, the main compartment portion is comprised of a bag slot and a cleaning wipe slot. Preferably, the plurality of cleaning wipes is accessible through the cleaning wipe slot and the plurality of bags is accessible through the bag slot. Preferably, the plurality of bags and the plurality of cleaning wipes are refillable. Preferably, the secondary compartment is configured to securely hold one or more small items selected from the group of small items consisting of one or more keys, one or more cards, and money. Preferably, the dog walking device resembles a dog house, but it may resemble a fire hydrant, tree, or other design that may contain bags and wipes. Preferably, the main compartment has an exterior that is comprised of a photo slot. Preferably, the photo slot is configured to accept a photo, such that the dog walking device is personalized. Preferably, the exterior of the main compartment is further comprised of a name plate, wherein the name plate is configured to have a name placed thereon, such that the dog walking device is further personalized. Preferably, the exterior of the main compartment is further personalized by accepting a logo mark. Preferably, the device includes a D-ring, wherein the D-ring is removably attached to the connector and personalized. Preferably, the connector resembles a handle selected from the handles consisting of a dog bone and a spiked collar or a portion of a spiked collar. Preferably, the device has a separator; wherein the separator is within the main compartment and separates the plurality of bags from the plurality of cleaning wipes.

Another embodiment of the invention is a dog walking device comprised of: a main compartment portion; and a secondary compartment; wherein the main compartment portion is configured to contain a plurality of bags and a plurality of cleaning wipes. Preferably the main compartment portion is comprised of a bottom, a top, and a plurality of sides and at least one of the plurality of sides is removable, such that there is at least one removably attachable side. Preferably, one of the sides is comprised of a bag slot and a cleaning wipe slot, wherein the plurality of cleaning wipes are accessible through the cleaning wipe slot and the plurality of bags are accessible through the bag slot. Preferably, the secondary compartment portion is comprised of the top and an outer cover; and the secondary compartment and the main compartment are accessible when the at least one removably attachable side is removed. The device preferably includes a connector; a separator; and a D-ring. Preferably: the connector is attached to an outer surface of the outer cover; the connector enables the dog walking device to connect to a pet leash; the separator is within the main compartment and separates the plurality of bags from the plurality of cleaning wipes; the plurality of bags and the plurality of cleaning wipes are refillable; the plurality of bags and the plurality of cleaning wipes are refillable; the dog walking device resembles a dog house; the D-ring is removably attached to the connector; the D-ring is personalized; the main compartment has an exterior that is comprised of a photo slot; the photo slot is configured to accept a photo, such that the dog walking device is personalized; the exterior of the main compartment is further comprised of a name plate, wherein the name plate is configured to have a name placed thereon, such that the dog walking device is further personalized; the exterior of the main compartment is further personalized by accepting a logo mark; and the secondary compartment is configured to securely hold one or more small items selected from the group of small items consisting of one or more keys, one or more cards, and money.

The invention is preferably customizable and will accept stickers, writing, or stamps, to place a pets name on the dog house and preferably has a place to put a picture of the pet. This may be one on a name plate portion of the exterior of the container. The container preferably has a place to hold waste bags and cleaning wipes (wet or dry). The container preferably has a connector, or D-ring to attach to leash. The invention attaches to a pet leash. Specifically, the device dangles from the leash and, after the pet creates waste, one of the bags is used to pick up the waste. In the event that a mess is created, the cleaning wipes may be used to clean up. Preferably, the cleaning wipes are antibacterial wipes. The used cleaning wipes can then be discarded. Alternatively, the container may have a separate compartment for the waste bag. Alternatively, the container may be clipped to a belt.

The invention preferably stores house keys and credit cards in the roof area and frees an owner's hands for walking the dogs. Although the preferred shape is a dog house, the invention may be different shapes such as a dog bone, tree house, tire, or fire hydrant.

Alternatively, this invention can be used in the car, diaper bag, or laundry room, or any place where frequent messy clean up is needed. The bags and cleaning wipes are refillable.

It is an object of the present invention to overcome the limitations of the prior art.

It is an object of the present invention to provide a container for holding and dispensing bags and cleaning wipes that must be carried when walking a pet.

It is an object of the present invention to provide a customizable container that looks like a dog house and has a hidden compartment for small objects, such as a key, credit card, driver's license card, or cash.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of the dog walking device as disassembled.

FIG. 2 is an illustration of a perspective view of one embodiment of the dog walking device.

FIG. 3 is an illustration of a perspective view of another embodiment of the dog walking device.

FIG. 4a is an illustration of a top portion of one embodiment of the dog walking device.

FIG. 4b is an illustration of a top portion of one embodiment of the dog walking device showing the secondary compartment.

FIG. 5a is an illustration of top portion of one embodiment of the dog walking device showing a dog bone connector.

FIG. 5b is an illustration of top portion of one embodiment of the dog walking device showing a spiked collar connector.

FIG. 6 is an illustration of one embodiment of the dog walking device showing a wipe and bag slot on an end of the device.

FIG. 7 is an illustration of one embodiment of the dog walking device showing that one side may be removed to refill the bags and cleaning wipes.

### DETAILED DESCRIPTION OF THE DRAWINGS

The drawings are of illustrative embodiments. They do not illustrate all embodiments. Other embodiments or variations of embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the Drawings, and the detailed descriptions thereof, are to be regarded as illustrative in nature and not restrictive. Also, the reference or non-reference to a particular embodiment of the invention shall not be interpreted to limit the scope of the invention.

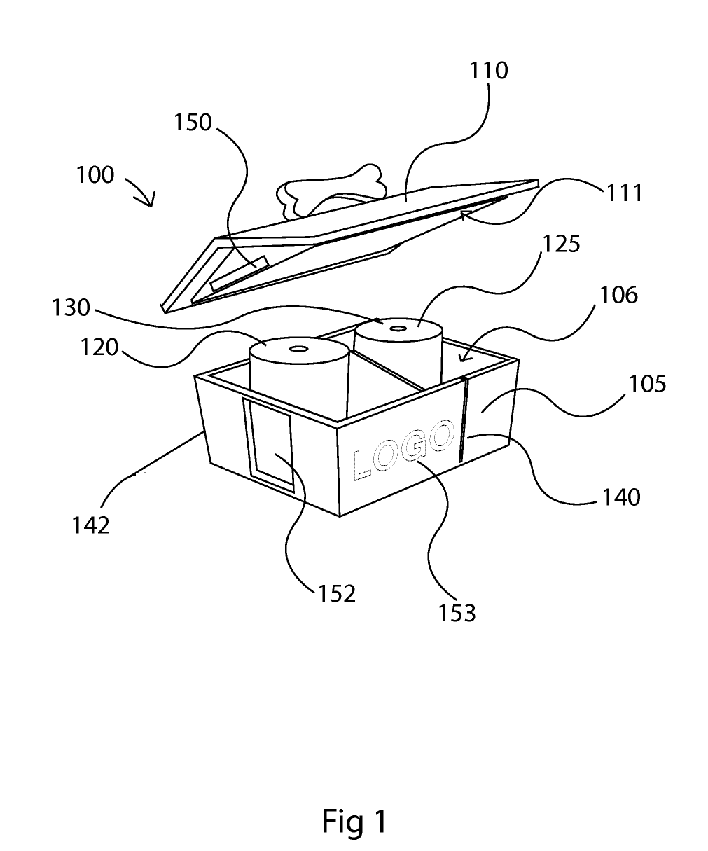

FIG. 1 is an illustration of a perspective view of one embodiment of the dog walking device as disassembled. As shown in FIG. 1, the dog walking device 100 is preferably comprised of main compartment portion 105, main compartment 106, top 110, secondary compartment 111, bags 120, cleaning wipes 125, separator 130, cleaning wipe slot 140, bag slot 142, name plate 150, photo slot 152, and logo mark 153. The top portion 110 or roof is preferably detachably connected to main compartment portion 105. FIG. 1 shows that the interior of the main compartment portion 105 is main compartment 106, which preferably contains bags 120 and cleaning wipes 125. The bags 120 and cleaning wipes 125 may be refilled once they run out. The bags 120 are preferably plastic bags that are configured to handle pet waste or excrement, but any kind of bag may be used without deviating from the scope of the invention. The cleaning wipes 125 may be dry or wet and are used to clean up pet waste or excrement. The separator 130, which is optional, preferably keeps the bags 120 and cleaning wipes separated from each other. The cleaning wipe slot 140 and bag slot 142 allow a user to access the bags 120 and cleaning wipes 125 in a single use manner. The photo slot 152, logo mark 153, and name plate 150 allow for customization and personalization of the dog walking device 100. The name plate 150 is typically a flat portion that is above the photo slot 152 and accepts writing, stamps, printing, or stickers of a name, such as a pet name. The photo slot 152 preferably accepts and holds securely one or more photos, usually of a pet. The logo mark 153 allows the user or seller to decorate or mark the dog walking device 100 to further customize or personalize the device.

FIG. 1 shows how dog walking device container 100 preferably resembles a dog house. The device 100 preferably is made of high impact plastic, but can be made from any durable material, such as composites, fibers, metals, or wood. The device 100 may also have other shapes, preferably related to pets or dog walking, such as a fire hydrant, dog bowl, tree, dog, or other similar shape.

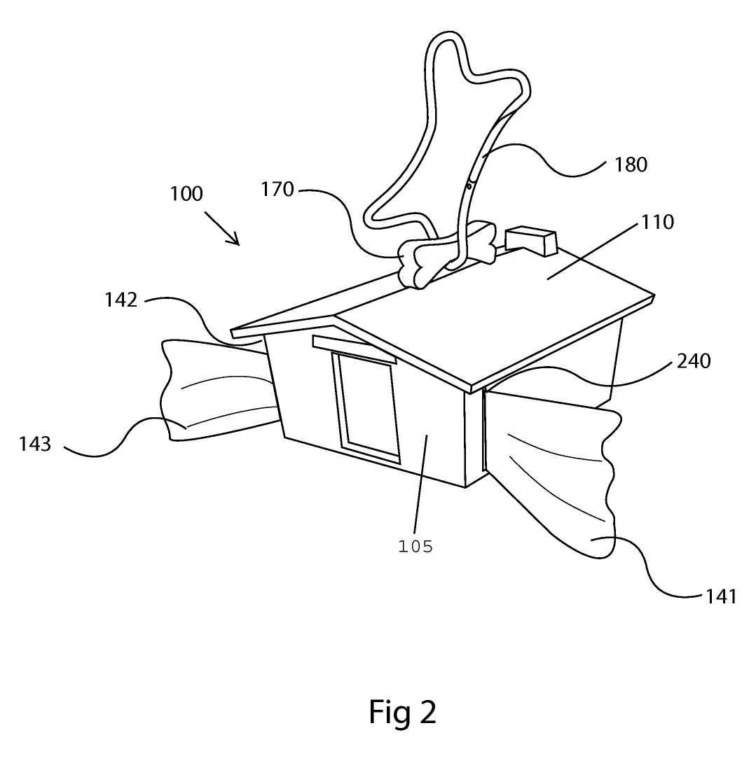

FIG. 2 is an illustration of a perspective view of one embodiment of the dog walking device. As shown in FIG. 2, the dog walking device container 100 encloses bags 143, which are accessed through bag slot 143, and cleaning wipes 141, which are accessed through cleaning wipe slot 240. A connector 170 is preferably attached to the exterior of top portion 110. A D-ring 180 is preferably removably connected to connector 170. The D-ring 180 and connector 170 allow the dog walking device to removably attach or connect to a leash, retractable leash, or belt of a user. FIG. 2 shows how the top portion 110 is preferably securely, but removably, connected to main compartment portion 105. The D-ring is preferably customizable.

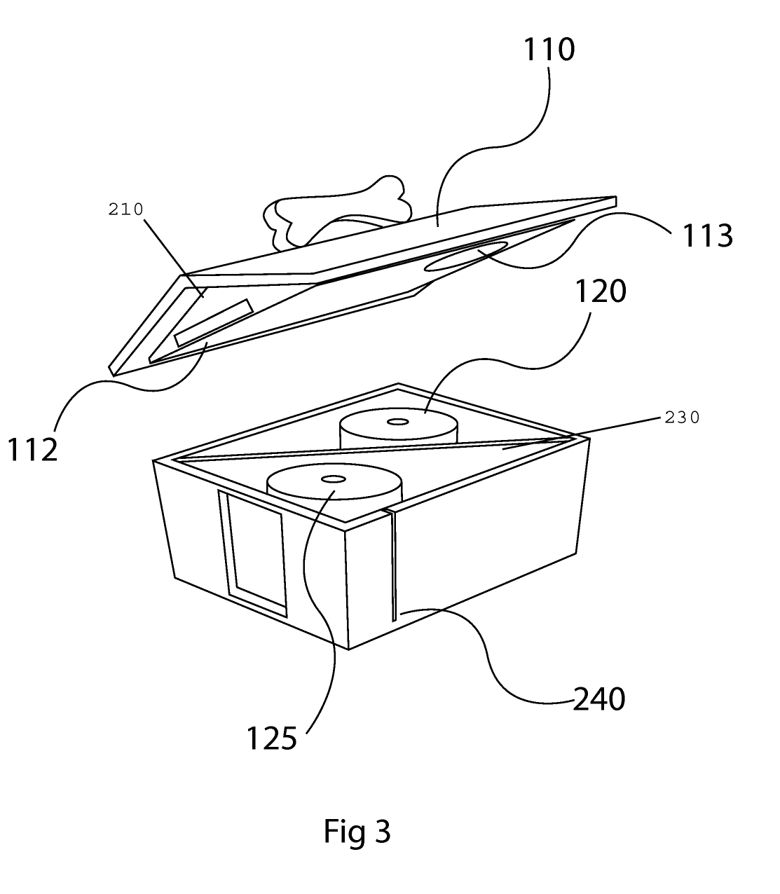

FIG. 3 is an illustration of a perspective view of another embodiment of the dog walking device. As shown in FIG. 3, the separator 230 and cleaning wipe slot 240 may be in different configurations. Additionally, top portion 110 is shown as comprising outer cover 210 and inner hatch 112. In hatch may have finger slot 113 to aid in separating inner hatch 112 from outer cover 210.

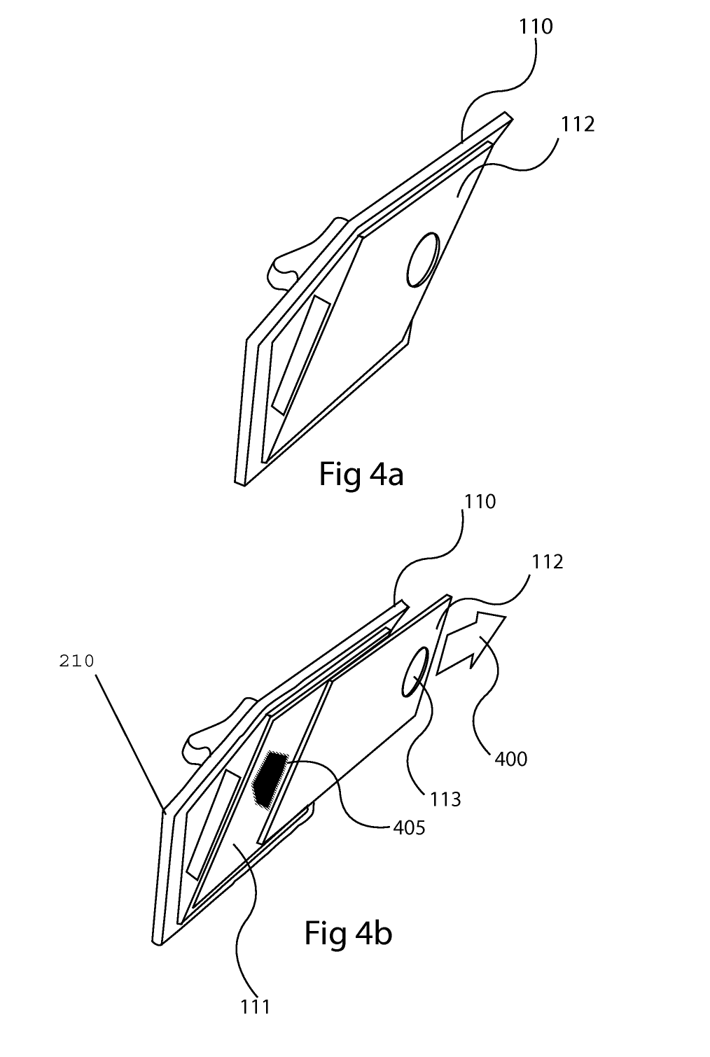

FIG. 4a is an illustration of a top portion of one embodiment of the dog walking device. As shown in FIG. 4a, the top portion 110 is preferably comprised of inner hatch 112 and outer cover 210.

FIG. 4b is an illustration of a top portion of one embodiment of the dog walking device showing the secondary compartment. FIG. 4b shows how inner hatch may be removed, typically by sliding, from the top portion 110 to reveal secondary compartment 111. Secondary compartment 111, which may be a hidden compartment may hold identification cards, driver's licenses, credit cards, keys, money, or other small items 405 so that they dog walking user does not have to worry about these small items.

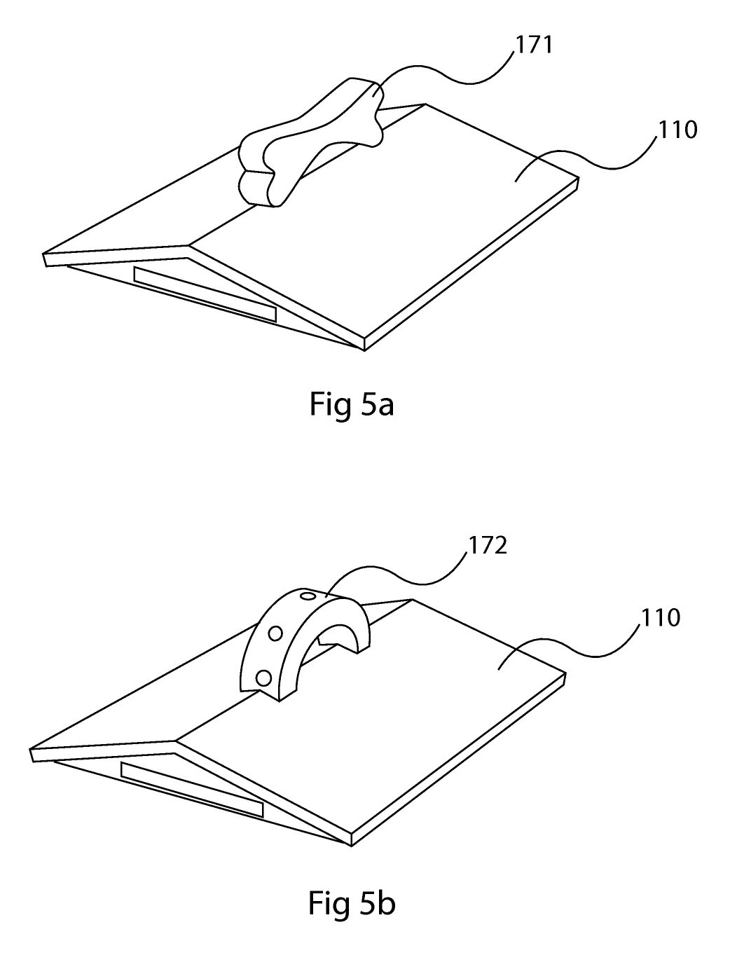

FIG. 5a is an illustration of top portion of one embodiment of the dog walking device showing a dog bone connector. FIG. 5a shows how the connector may be a dog bone connector 171.

FIG. 5b is an illustration of top portion of one embodiment of the dog walking device showing a spiked collar connector. FIG. 5b shows how the connector may be a spiked collar, or portion of a spiked collar connector 172.

Although FIGS. 5a and 5b show, as preferred, that the connector is personalized with a specific shape, any shape, preferably pet or dog walking related may be used.

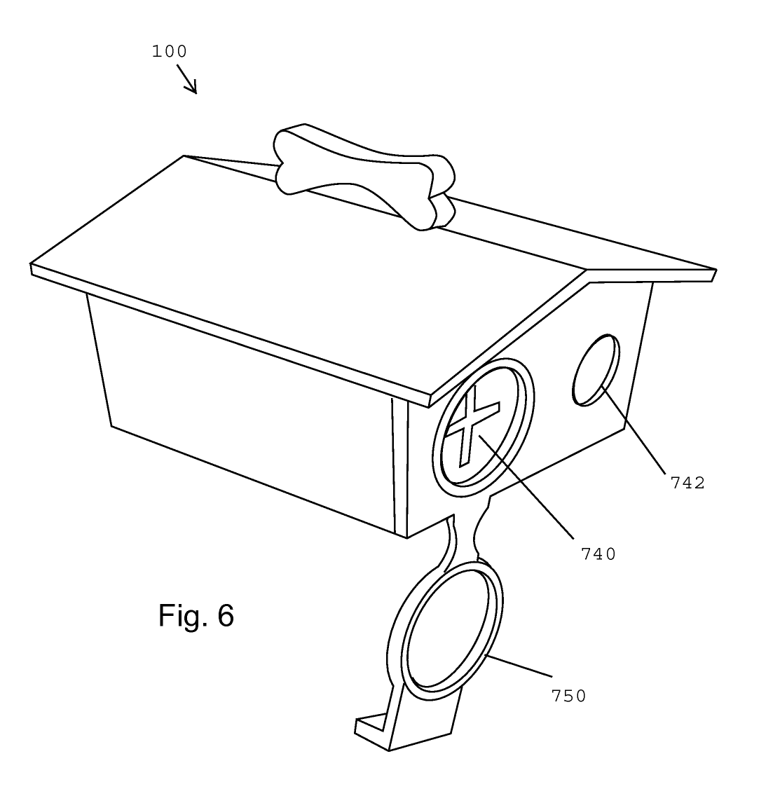

FIG. 6 is an illustration of one embodiment of the dog walking device showing a wipe and bag slot on an end of the device. As shown in FIG. 6, the dog walking device 100 may also have bag slot 742 and cleaning wipe slot 740. The slots 740 and 742 are preferably one piece dispenser slots so that a user may easily remove just one cleaning wipe or just one bag.

FIG. 6 shows how cleaning wipe slot 740 may include attached cap 750, which helps prevent wet wipes from drying out or becoming dirty. In the embodiment shown in FIG. 6, the top portion is typically not removable.

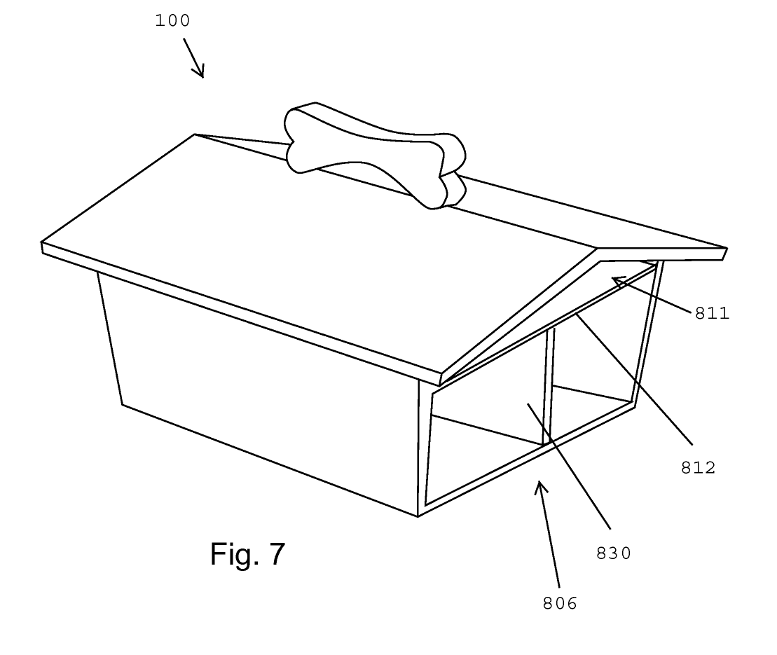

FIG. 7 is an illustration of one embodiment of the dog walking device showing that one side may be removed to refill the bags and cleaning wipes. FIG. 7 shows how the side, rather than the top of main compartment 806 may be removed in order to refill the bags and the cleaning wipes and to access secondary compartment 811. FIG. 7 shows also shows separator 830 dividing main compartment 806. The main compartment 806 is separated from secondary compartment 811 by top 812, also referred to as an inner hatch.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A dog walking device comprising:
a main compartment portion; and
a top portion;
wherein said main compartment portion is configured to contain a plurality of bags and a plurality of cleaning wipes;
wherein said top portion removably connects to said main compartment portion.

2. The device of claim 1, wherein said top portion is comprised of an outer cover, an inner hatch, and a secondary compartment;
wherein said secondary compartment is formed by said outer cover and said inner hatch;
wherein said inner hatch removably connects to said cover.

3. The device of claim 2, further comprising:
a connector,
wherein said connector is attached to an outer surface of said outer cover; and
wherein said connector enables said dog walking device to connect to a pet leash.

4. The device of claim 3, wherein said main compartment portion is comprised of a bag slot and a cleaning wipe slot;
wherein said plurality of cleaning wipes are accessible through said cleaning wipe slot; and
wherein said plurality of bags are accessible through said bag slot.

5. The device of claim 4, wherein said plurality of bags and said plurality of cleaning wipes are refillable.

6. The device of claim 5, wherein said secondary compartment is configured to securely hold one or more small items selected from the group of small items consisting of one or more keys, one or more cards, and money.

7. The device of claim 4, wherein said dog walking device resembles a dog house.

8. The device of claim 4, wherein said main compartment has an exterior that is comprised of a photo slot;
wherein said photo slot is configured to accept a photo, such that said dog walking device is personalized.

9. The device of claim 8, wherein said exterior of said main compartment is further comprised of a name plate, wherein said name plate is configured to have a name placed thereon, such that said dog walking device is further personalized.

10. The device of claim 9, wherein said exterior of said main compartment is further personalized by accepting a logo mark.

11. The device of claim 4, further comprising a D-ring, wherein said D-ring is removably attached to said connector.

12. The device of claim 11, wherein said D-ring is personalized.

13. The device of claim 4, wherein said connector resembles a handle selected from the handles consisting of a dog bone and a spiked collar.

14. The device of claim 4, further comprising a separator;
wherein said separator is within said main compartment and separates said plurality of bags from said plurality of cleaning wipes.

15. A dog walking device comprising:
a main compartment portion;
a top portion;
a separator;
a connector; and
a D-ring;
wherein said main compartment portion is configured to contain a plurality of bags and a plurality of cleaning wipes;
wherein said top portion removably connects to said main compartment portion;
wherein said top portion is comprised of an outer cover, an inner hatch, and a secondary compartment;
wherein said secondary compartment is formed by said outer cover and said inner hatch;
wherein said inner hatch removably connects to said cover;
wherein said connector is attached to an outer surface of said outer cover;
wherein said connector enables said dog walking device to connect to a pet leash;
wherein said main compartment portion is comprised of a bag slot and a cleaning wipe slot;
wherein said plurality of cleaning wipes are accessible through said cleaning wipe slot and said plurality of bags are accessible through said bag slot;
wherein said plurality of bags and said plurality of wipes are refillable;
wherein said secondary compartment is configured to securely hold one or more small items selected from the group of small items consisting of one or more keys, one or more cards, and money;
wherein said dog walking device resembles a dog house;
wherein said main compartment has an exterior that is comprised of a photo slot;
wherein said photo slot is configured to accept a photo, such that said dog walking device is personalized;
wherein said exterior of said main compartment is further comprised of a name plate;
wherein said name plate is configured to have a name placed thereon, such that said dog walking device is further personalized;
wherein said exterior of said main compartment is further personalized by accepting a logo mark;
wherein said D-ring is removably attached to said connector;
wherein said D-ring is personalized;
wherein said connector resembles a handle selected from the handles consisting of a dog bone and a spiked collar; and
wherein said separator is within said main compartment and separates said plurality of bags from said plurality of cleaning wipes.

16. A dog walking device comprising:
a main compartment portion; and
a secondary compartment;
wherein said main compartment portion is configured to contain a plurality of bags and a plurality of cleaning wipes.

17. The device of claim 16, wherein said main compartment portion is comprised of a bottom, a top, and a plurality of sides;
wherein at least one of said plurality of sides is removable, such that there is at least one removably attachable side;
wherein at least one of said plurality of sides is comprised of a bag slot and a cleaning wipe slot;
wherein said plurality of cleaning wipes are accessible through said cleaning wipe slot and said plurality of bags are accessible through said bag slot;
wherein said secondary compartment portion is comprised of said top and an outer cover; and
wherein said secondary compartment and said main compartment are accessible when said at least one removably attachable side is removed.

18. The device of claim 17, further comprising:
a connector;
a separator; and
a D-ring;
wherein said connector is attached to an outer surface of said outer cover;
wherein said connector enables said dog walking device to connect to a pet leash;
wherein said separator is within said main compartment and separates said plurality of bags from said plurality of cleaning wipes;
wherein said plurality of bags and said plurality of cleaning wipes are refillable;
wherein said plurality of bags and said plurality of cleaning wipes are refillable;
wherein said dog walking device resembles a dog house; and
wherein said D-ring is removably attached to said connector.

19. The device of claim 18, wherein said D-ring is personalized;
wherein said main compartment has an exterior that is comprised of a photo slot;
wherein said photo slot is configured to accept a photo, such that said dog walking device is personalized;
wherein said exterior of said main compartment is further comprised of a name plate;
wherein said name plate is configured to have a name placed thereon, such that said dog walking device is further personalized; and
wherein said exterior of said main compartment is further personalized by accepting a logo mark.

20. The device of claim 19, wherein said secondary compartment is configured to securely hold one or more small items selected from the group of small items consisting of one or more keys, one or more cards, and money.
